(19) United States
(12) Patent Application Publication
(10) Pub. No.: US 2018/0335030 A1
(43) Pub. Date: Nov. 22, 2018

(54) FOUNTAIN PUMP BRACKET

(71) Applicant: Foothill Land, LLC, Newport Coast, CA (US)

(72) Inventor: Benjamin R. Du, Newport Coast, CA (US)

(21) Appl. No.: 15/598,005

(22) Filed: May 17, 2017

(51) Int. Cl. F04B 53/16; F04B 19/22; F04B 15/02; F04B 9/123; F04B 53/10; B67D 1/00; B67D 1/08; B67D 1/10

(52) U.S. Cl. CPC F04B 53/16; F04B 19/22; F04B 15/02; F04B 9/123; F04B 53/10; B67D 2001/0094; B67D 1/0889; B67D 1/101; B67D 2001/0091; B67D 2001/0097; B67D 1/0042

(57) ABSTRACT

A mounting bracket specifically configured and adapted to allow for quick and easy mounting of a fluid pump, such as a pump commonly used in dispensing fountain drinks. The mounting bracket includes fluid passageway(s) which are fluidly connectable with corresponding passageways(s) on the pump, a pressurized gas control source, as well as adjacent mounting bracket(s), such that the pump is automatically connected to such passageways to facilitate operation of the pump upon engagement of the pump in the mounting bracket.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to a mounting system for a gas-driven pump, and more specifically to a modular mounting bracket system for mounting a plurality of pumps and providing a fluid interconnection therebetween.

### 2. Description of the Related Art

Beverage dispensers, such as soda fountains, are commonly used in restaurants, concessions stands and other locations for easily dispensing beverages, particularly carbonated soft drinks. Such conventional beverage dispensers may be adapted to dispense several different beverages, and thus, most beverage dispensers generally include a plurality of compressed gas operated pumps, a plurality of dispensing nozzles, and a plurality of containers (e.g., bag-in-box) for storing the soda syrup. Typically, each pump is fluidly connected to one of the dispensing nozzles, and one of the containers for pumping soda syrup associated with a particular beverage to the dispensing nozzle. A source of pressurized gas is usually located near the plurality of pumps to provide the pressurized gas needed to operate the pumps.

Given the various components associated with the beverage dispenser, several tubes, valves, and other fluid interconnections are typically required to facilitate fluid flow through the overall system. For instance, separate fluid lines may extend between each pump and the source of pressurized fluid, with each line having a dedicated control valve to enable user control of the flow of fluid through the fluid line. Since each pump requires connection to the source of pressurized fluid, installation of the beverage dispenser may be a tedious and time consuming process. Furthermore, maintenance and repair of the pumps may also be tedious, in view of the dedicated plumbing lines associated with each pump.

Accordingly, there is a need in the art for a mounting bracket for easily mounting gas-operated pumps and facilitating fluid connections to the pump upon engagement of the pump to the mounting bracket. Various aspects of the present disclosure address this particular need, as will be discussed in more detail below.

### BRIEF SUMMARY

In accordance with one embodiment of the present disclosure, there is provided a mounting bracket specifically configured and adapted to allow for quick and easy mounting of a fluid pump, such as a pump commonly used in dispensing fountain drinks. The mounting bracket includes fluid passageway(s) which are fluidly connectable with corresponding passageways(s) on the pump, a pressurized gas control source, as well as adjacent mounting bracket(s), such that the pump is automatically connected to such passageways to facilitate operation of the pump upon engagement of the pump in the mounting bracket.

According to one embodiment, there is provided a mounting bracket for a pressurized fluid operated pump having a pressurized fluid inlet and a pressurized fluid outlet. The mounting bracket includes a body having a first mounting region and a second mounting region, with the body being configured to be engageable with the pump. A first fluid passageway extends between the first mounting region and the second mounting region. The first fluid passageway has a pair of first ports located at respective ones of the first mounting region and the second mounting region. The mounting bracket further includes a second fluid passageway separate from the first fluid passageway and extending between the first mounting region and the second mounting region. The second fluid passageway has a pair of second ports located at respective ones of the first mounting region and the second mounting region. A first valve is coupled to the body and is in fluid communication with the first fluid passageway, with the first valve being in a normally closed position. A second valve is coupled to the body and in fluid communication with the second fluid passageway, with the second valve being in a normally closed position. The first valve and the second valve are configured to transition from their respective normally closed positions to respective open positions in response to engagement of the pump with the body to fluidly couple the pressurized fluid inlet and the pressurized fluid outlet with respective ones of the first and second fluid passageways. The first mounting region and the second mounting region are configured to be engageable with respective ones of adjacent mounting brackets.

The first mounting region may include a male connector and the second mounting region may include a female connector.

The body may include a pair of opposed ridges adapted to engage with a corresponding pair of grooves on the pump to align the pump relative to the bracket when the pump is engaged with the bracket. The body may include a cavity and a locking mechanism, with the cavity being configured to receive at least a portion of the pump, and the locking mechanism being configured to engage with the pump when the at least a portion of the pump is received in the cavity to retain the at least a portion of the pump within the cavity. The cavity may be at least partially defined by a base plate, and the locking mechanism may include a tab moveable relative to the base plate.

The mounting bracket may further comprise a first tube coupled to the body and defining the first fluid passageway, and a second tube coupled to the body and defining the second fluid passageway.

The mounting bracket may additionally include a pair of fluid couplings adapted to be insertable within respective ones of the first and second passageways. The mounting bracket may also comprise a retaining clip moveable relative to the body between an engaged position and a released position, with the retaining clip engaging the pair of fluid couplings to retain the fluid couplings in fluid communication with the respective ones of the first and second passageways when the retaining clip is in the engaged position, and the retaining clip being spaced from the pair of couplings to allow for removal of the fluid couplings from the respective ones of the first and second passageways when the retaining clip is in the released position.

The mounting bracket may further comprise a pair of end caps insertable within respective ones of the first and second passageways, with each end cap being configured to block the respective one of the first and second passageways when inserted therein.

According to another embodiment, there is provided a modular mounting system for a plurality of fluid pumps. The modular mounting system includes a plurality of mounting brackets, with each mounting bracket comprising a body having a first mounting region and a second mounting region. The body is configured to be engageable with a respective one of the plurality of pumps. At least one control passageway extends between the first mounting region and the second mounting region and includes at least one port, with the at least control passageway being fluidly connectable to a pressurized fluid source. A valve is coupled to the body and is in fluid communication with the at least one control passageway, with the valve being in a normally closed position. The valve is configured to transition from the normally closed position to an open position in response to engagement of the pump with the body to fluidly couple the pump to the at least one control passageway. The plurality of mounting brackets are selectively engageable with each other by connecting the first mounting region of a first one of the plurality of mounting brackets with the second region of a second one of the plurality of mounting brackets. The at least one control passageways of the plurality of mounting brackets are in fluid communication with each other when the plurality of mounting brackets are engaged with each other.

According to yet another embodiment, there is provided a mounting bracket for a gas-driven pump. The mounting bracket includes a body configured to be releasably engageable with the pump. A fluid control passageway extends within the body and has a pair of ports configured to allow for selective fluid connection with a separate, adjacent mounting bracket. A check-valve is coupled to the body and is in fluid communication with fluid control passageway. The check-valve is configured to transition from a normally closed position to a normally open position in response to engagement of the pump with the body.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of a modular mounting system including a plurality of mounting brackets for mounting a plurality of fluid pumps, with one pump being removed from its corresponding mounting bracket;

FIG. 2 is a perspective view of the pump used with the mounting system;

FIG. 3 is a side, partial cross sectional view of a pump detached from a mounting bracket;

FIG. 4 is a side, partial cross sectional view of the pump engaged with the mounting bracket;

FIG. 5 is a rear perspective view of the mounting bracket;

FIG. 6 is an upper perspective view of a plurality of interconnected mounting brackets;

FIG. 7 is an exploded upper perspective view of a plurality of mounting brackets, interconnecting fluid couplings, and end caps;

FIG. 8 is an exploded upper perspective view of a mounting bracket including a body, fluid couplings, fluid tubes, and locking tabs;

FIG. 9 is a lower perspective view of the mounting bracket with the fluid couplings detached from the body;

FIG. 10 is an upper perspective view of the locking tab;

FIG. 11 is an enlarged cross sectional view depicting the fluid couplings retained in fluid communication with a fluid passageway within the body;

FIG. 12 is an enlarged cross sectional view taken along line 12-12 of FIG. 11, depicting engagement between the locking tab and the fluid couplings; and

FIGS. 13 and 14 are cross sectional views depicting a sequence of unlocking the locking tab to allow for removal of the fluid couplings from the body.

Common reference numerals are used throughout the drawings and the detailed description to indicate the same elements.

### DETAILED DESCRIPTION

The detailed description set forth below in connection with the appended drawings is intended as a description of certain embodiments of a mounting bracket for a fluid pump and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Referring now to the drawings, wherein the showings are for purposes of illustrating a preferred embodiment of the present disclosure, and are not for purposes of limiting the same, there is depicted a modular mounting system 10 for mounting a plurality of pressurized gas operated fluid pumps 12. The mounting system 10 includes a plurality of mounting brackets 14, wherein each mounting bracket 14 is adapted to engage with a respective pump 12. The mounting system 10 includes integrated plumbing and valves for fluidly connecting the pump 12 to an external pressurized fluid source when the pump 12 is engaged with the bracket 14. In this regard, plumbing connections and check valves separate from those integrated into the brackets 14 may not be required, thereby simplifying installation and maintenance of the pumps 12. Therefore, the mounting system 10 provides cost savings to the user through the simplified installation of the pumps 12.

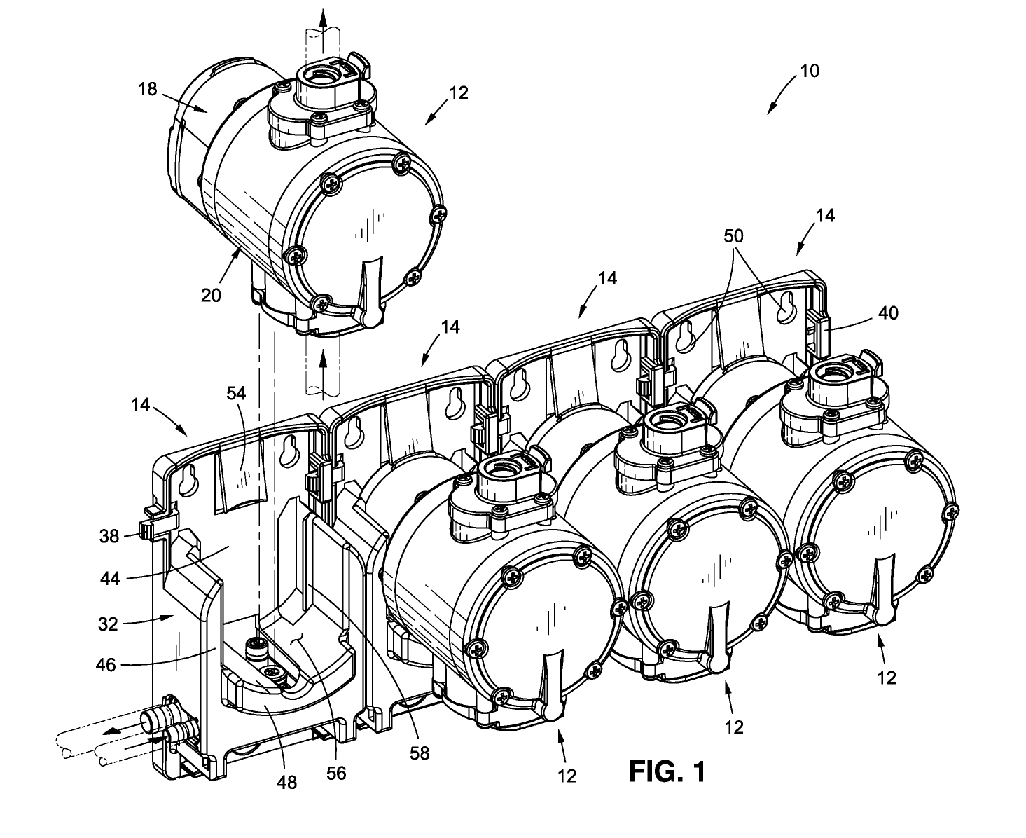

FIG. 1 is an upper perspective view of the modular mounting system 10 including an array of four interconnected mounting brackets 14 and four pumps 12. Three of the four pumps 12 are connected to their corresponding mounting brackets 14, while the remaining pump 12 is separated from its mounting bracket 14 to illustrate the detachable engageability between the pumps 12 and the mounting brackets 14.

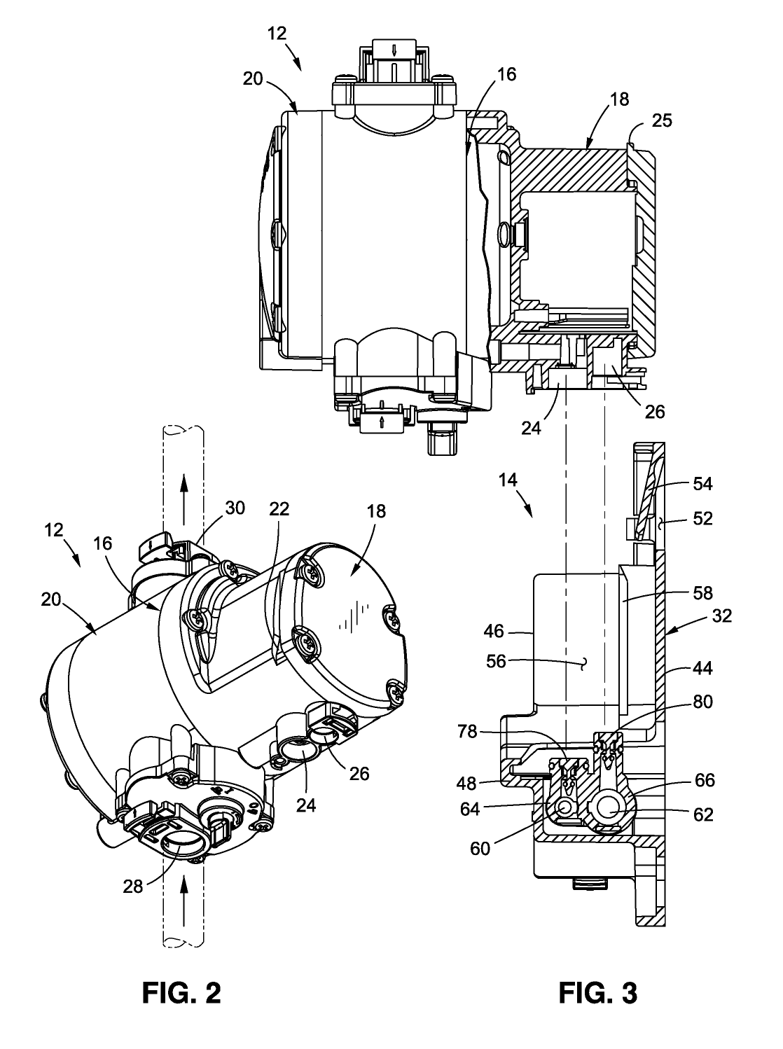

Referring now to FIG. 2, the pumps 12 which are used with the mounting brackets 14 are pumps operated by pressurized fluid, such as compressed gas (e.g., CO₂), which drives a pumping piston or other drive mechanism for pumping fluid through the pump 12. Such pumps 12 are oftentimes used in the beverage industry for pumping soda syrup to a beverage dispenser nozzle. The pump 12 generally includes a pump body 16 having a first end portion 18 and a second end portion 20. The first end portion 18 is smaller than the second end portion 20, and is configured to be engaged with the mounting bracket 14. The exemplary embodiment of the pump body 16 includes a pair of opposed grooves 22 formed in the pump body 16 to facilitate alignment and engagement with the mounting bracket 14, as will be explained in more detail below. The pump 12 also includes a pressurized fluid inlet 24 and a pressurized fluid outlet 26, both of which are formed on the first end portion 18 of the pump body 16, and are arranged in a stacked configuration, i.e., one right next to the other. The pressurized fluid inlet 24 and pressurized fluid outlet 26 are also located between the pair of opposed grooves 22. The pump 12 may also include a lip 25 adapted to engage with a locking mechanism on the bracket 14, as will be described in more detail below.

To operate the pump 12, a source of pressurized fluid is connected to the pressurized fluid inlet 24 to drive an internal pump piston (not shown). The pressurized fluid used to drive the pump 12 is then discharged from the pump 12 via the pressurized fluid outlet 26. The pump 12 shown in FIG. 2 also shows a main fluid inlet 28 and a main fluid outlet 30, which is separate from the pressurized fluid inlet 24 and pressurized fluid outlet 26. The main fluid inlet 28 receives the fluid that is to be pumped, such as soda syrup, which is then discharged through the main fluid outlet 30. For more information regarding the pump 12, please refer to U.S. Pat. No. 9,249,792 entitled Bag in Box Beverage Pump, the contents of which are expressly incorporated herein by reference.

To mount the pump 12 in a preferred location, such as close to an associated beverage dispenser nozzle, each pump 12 is attached to a corresponding mounting bracket 14. Thus, if several pumps 12 are used, several mounting brackets 14 will also be used and will be interconnected to each other. To facilitate interconnection between the brackets 14, each mounting bracket 14 includes a body 32 having a first mounting region 34 and a second mounting region 36 for selectively connecting/disconnecting the mounting bracket 14 to/from adjacent mounting brackets 14. As such, the mounting regions 34, 36 are configured to allow for selective sizing of the overall number of mounting brackets 14 included in the system 10.

In the exemplary embodiment, the first mounting region 34 extends along a first lateral portion of the body 32 and includes a male connector 38, i.e., a tab, while the second mounting region 36 extends along an opposing second lateral portion of the body 32 and includes a female connector 40, i.e., an opening, adapted to receive the tab on an adjacent mounting bracket 14. When the connectors 38, 40 are engaged with each other, the adjacent lateral sides of the brackets 14 may be in abutting relation to each other. The male and female connectors 38, 40 are aligned along a common axis 42 to allow for easy engagement with the corresponding male and female connectors 38, 40 on the adjacent mounting bracket(s) 14. Although, when viewed from the perspective depicted in FIG. 1, the exemplary embodiment includes the male connector 38 on the left-side of the body 32 and the female connector 40 on the right-side of the body 32, it is contemplated that the arrangement may be reversed without departing from the spirit and scope of the present disclosure.

The body 32 additionally includes a base plate 44, a pair of sidewalls 46 extending from the base plate 44 in opposed relation to each other, and an end wall 48 extending from the base plate 44 and between the pair of sidewalls 46. The base plate 44 includes a pair of apertures 50 to facilitate attachment of the mounting bracket 14 to an underlying support surface with screws, nails, rivets, or the like. The base plate 44 additionally includes an opening 52 adapted to accommodate a locking tab 54, as will be described in more detail below.

The sidewalls 46, end wall 48, and base plate 44 define a cavity 56 configured to receive the first end portion 18 of the pump 12. In this regard, the size and shape of the sidewalls 46 and end wall 48, and the corresponding cavity 56 is at least generally complimentary in shape to that of the first end portion 18 of the pump 12. For instance, the spacing between the sidewalls 46 is generally equal to the spacing between the corresponding opposed surfaces of the first end portion 18 of the pump 12 which reside adjacent the sidewalls 46 when the pump 12 is received in the cavity 56. Along these lines, while certain surfaces of the pump 12 may be rounded, the opposed surfaces of the first end portion 18 of the pump 12 may be generally planar to facilitate insertion of the pump 12 into the cavity 56. Furthermore, the end wall 48 may include curved or arcuate surface which is complimentary to a corresponding curved or arcuate surface formed on the pump 12. In the exemplary embodiment, the pump 12 includes a convex surface, and the end wall 48 includes a complimentary concave surface.

The body 32 further includes a pair of opposed ridges or spines 58 adapted to engage with the corresponding pair of grooves 22 on the pump 12 to align the pump 12 relative to the bracket 14 when the pump 12 is inserted into the cavity 56 for engagement with the bracket 14. Each ridge 22 extends along an axis which is parallel to the direction in which the pump 12 is inserted into the bracket 14, and subsequently removed from the bracket 14.

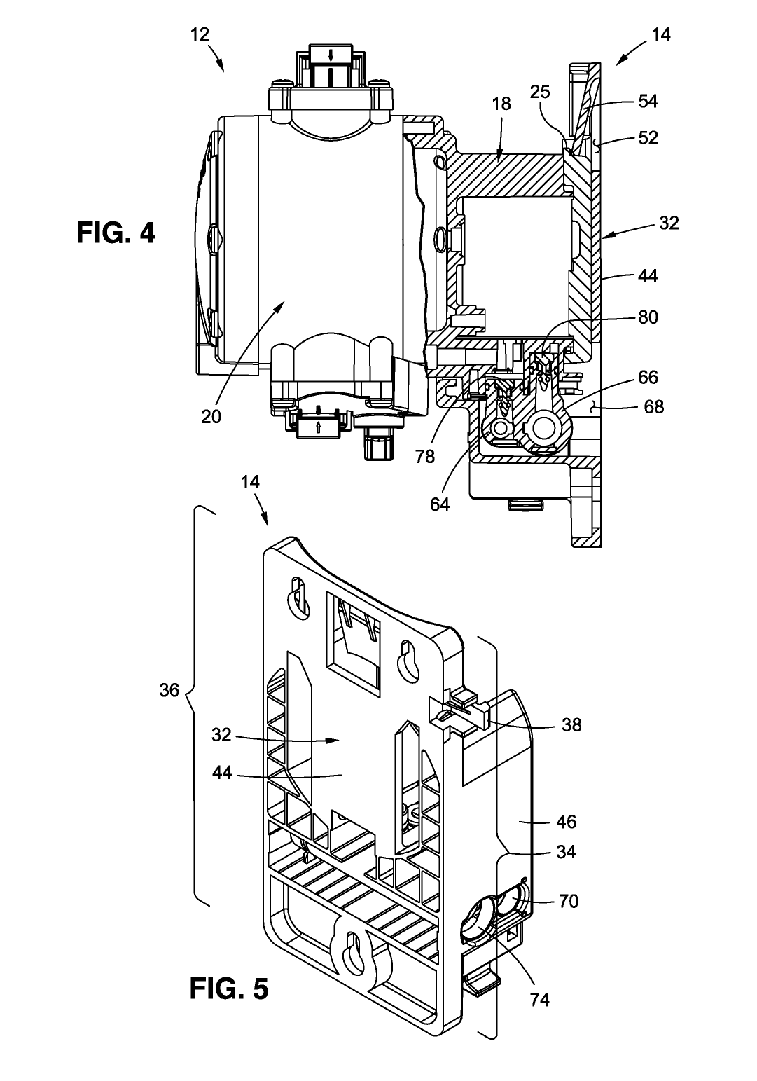

As noted above, the mounting bracket 14 additionally includes locking mechanism 54 configured to engage with the pump 12 when the at least a portion of the pump 12 is received in the cavity 56 to retain the pump 12 within the cavity 56 and engaged with the body 32. In the exemplary embodiment, the locking mechanism 54 includes a tab moveable relative to the base plate 44. The tab is moveable relative to the base plate 44 between a lock position, as shown in FIGS. 3 and 4, and an unlock position. When the tab is in the lock position, the tab engages with the pump 12 and is biased against the lip 25 to inhibit removal of the pump 12 from the cavity 56. To remove the pump 12, the tab is transitioned from the lock position toward the unlock position by pivoting the tab toward the plane in which the base plate 44 resides. When the tab is in the unlock position, the tab no longer impedes removal of the pump 12 from the cavity 56. The tab may be biased toward the lock position, such that when the tab is not acted on by the user, the tab resides in the lock position. Furthermore, the tab may be angled relative to the base plate 44 to allow the movement of the pump 12 into the cavity 56 to automatically transition the tab from the lock position toward the unlock position. However, in order to remove the pump 12, the user is required to press on the tab to move the tab into the unlock position.

In addition to securing the pump 12 in place, the mounting bracket 14 is additionally configured to effectuate fluid communication between an external fluid control source and the pump 12 when the pump 12 is seated within the bracket 14. In this regard, the mounting bracket 14 includes integrated fluid connections that interface with the pressurized fluid inlet 24 and the pressurized fluid outlet 26 of the pump 12. The fluid connections are adapted to allow for selective addition or removal of a pump 12 with regard to the overall pumping system 10.

According to one embodiment, the mounting bracket 14 includes a first fluid passageway 60 and a second fluid passageway 62, both of which extend between the first mounting region 34 and the second mounting region 36. A first tube 64 is coupled to the body 32 and defines the first fluid passageway 60, and a second tube 66 is coupled to the body 32 and defines the second fluid passageway 62. The first and second tubes 64, 66 may reside within a cavity 68 formed within the body 32. The first and second tubes 64, 66 may be joined together to form a single unit, or alternatively, may be separate bodies.

The first fluid passageway 60 is connectable to the source of pressurized fluid and is configured to receive the pressurized fluid therefrom and deliver the pressurized fluid to the pump 12. The second fluid passageway 62 receives exhausted fluid from the pump 12, and routes the exhausted fluid away from the pump 12. In this regard, since the first and second fluid passageways 60, 62 are fluidly connectable with the pump 12 to control operation of the pump 12, the first and second fluid passageways may be referred to as “control passageways.”

The first fluid passageway 60 extends through the body 32 of the mounting bracket 14 and includes port 70 located at the first mounting region 34 and port 72 at the second mounting region 36. Similarly, the second fluid passageway 62 includes port 74 at the first mounting region 34 and port 76 at the second mounting region 36. The ports 70, 72, 74, 76 are configured to allow fluid to enter and leave the first and second fluid passageways 60, 62.

The mounting bracket 12 further includes a pair of valves in communication with the first and second passageways to control fluid communication between the mounting bracket 14, and the pump 12. In particular, a first valve 78 is coupled to the body 32 and in fluid communication with the first fluid passageway 60, and a second valve 80 is coupled to the body 32 and in fluid communication with the second fluid passageway 62. According to one embodiment, the first and second valves 78, 80 are both configured to be in a normally closed position, and are actuated to the open position in response to engagement between the pump 12 and the bracket 14. In this regard, if the bracket 14 is connected to a pressurized fluid source prior to the pump 12 being engaged with the bracket 14, the pressurized fluid will not flow through the first and second valves 78, 80 until the pump 12 is connected to the bracket 14. For instance, the pump 12 may include a structural component that unseats a valve element in both the first and second valves 78, 80 when the pump 12 is engaged with the bracket 14, thereby transitioning the first and second valves 78, 80 to their respective open positions. The first and second valves 78, 80 remain in their open positions while the pump 12 remains engaged with the bracket 14. However, upon removal of the pump 12 from the bracket 14, the valve elements are biased back to their closed positions.

The mounting bracket 14 further includes a plurality of fluid fittings insertable into the various ports of the bracket 14. In particular, the fluid fittings may include intermediate fluid couplings 82, terminal fluid couplings 83, and end caps 85. The intermediate fluid couplings 82 facilitate fluid connection of one mounting bracket 14 with an adjacent mounting bracket 14. The terminal fluid couplings 83 facilitate fluid communication between the mounting bracket 14, and a pressurized fluid source, or an exhaust reservoir. The end caps 85 effectively close or cap-off a fluid passageway in the mounting bracket 14.

The intermediate fluid couplings 82 include a coupling body 84 having a pair of opposed end faces 86, and an opening 88 extending through the coupling body 84 between the pair of end faces 86. The fluid coupling 82 additionally includes a pair of seals in the form of O-rings 90 received within a respective circumferential groove 92 formed on the coupling body 84. Each O-ring 90 is adapted to form a fluid-tight seal between the coupling body 84 and the respective mounting bracket body 32 when the fluid coupling 82 is advanced into the mounting bracket body 32. Each fluid coupling 82 additionally includes a pair of grooves 94 for retaining the fluid coupling 82 to the respective mounting bracket body 32, as will be described in more detail below.

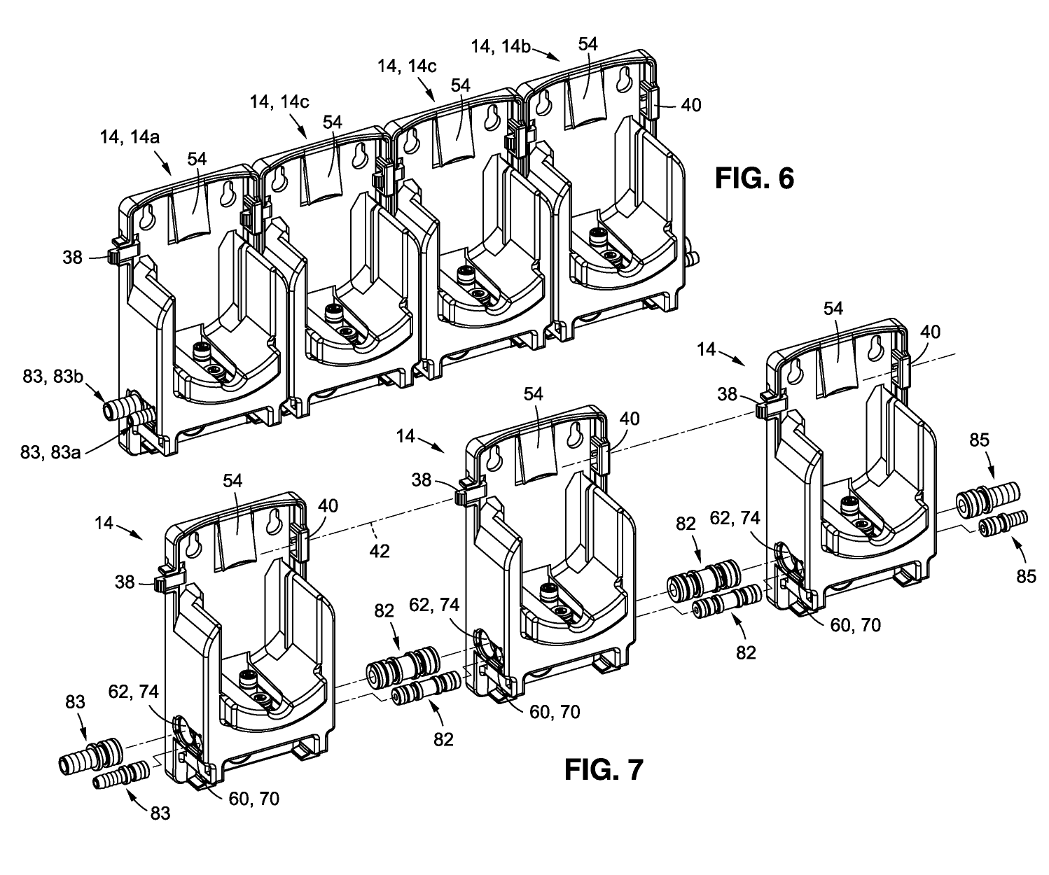

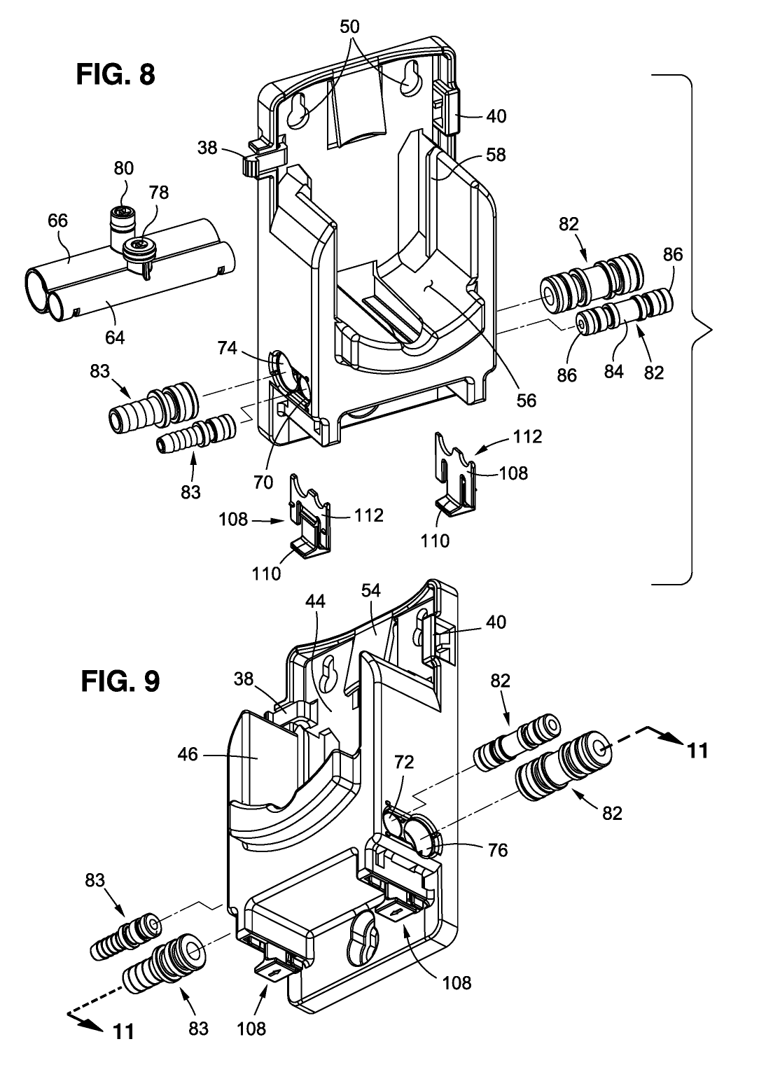

When a fluid coupling 82 is connecting one mounting bracket 14 to an adjacent mounting bracket 14, fluid may be transferred from a fluid passageway in one mounting bracket 14 to a fluid passageway in the other mounting bracket 14 via the fluid coupling 82. Furthermore, the fluid couplings are configured so as to not interfere with the physical connection between the connectors 38, 40 joining the mounting brackets 14 together. As can be seen in FIG. 6, when adjacent mounting brackets 14 are connected to each other, the interconnecting fluid couplings 82 may be hidden from view, with the fluid couplings 82 being primarily received within the fluid passageways between which the respective couplings extend. It is also noted that the fluid couplings

The terminal fluid couplings 83 may be connected to a respective mounting bracket body 32 for connecting the mounting bracket body 32 to an external fluid source or exhaust. Each terminal fluid coupling includes a body 96 having a barbed end portion 98, and a sealing end portion 100. The sealing end portion includes groove 102, which receives an o-ring 104 for creating a fluid tight seal between the body 96 and the mounting bracket body 32. Groove 106 is also formed in the sealing end portion 100 for retaining the terminal fluid coupling 83 to the mounting bracket body 32. The barbed end portion 98 includes a plurality of barbs adapted to engage with a flexible tube or hose to effectuate connection with the pressurized fluid source or exhaust.

The end caps 85 are fluid couplings that have one end adapted to be inserted into a fluid passageway of the mounting bracket 14, and another end that is closed to prevent fluid flow through the end cap 85. In this regard, the end cap 85 effectively closes off one end of the fluid passageway within which the end cap 85 is inserted. In one embodiment, the end cap is similar to the terminal fluid coupling 83, although instead of having an opening extending therethrough, the end cap 85 is closed off.

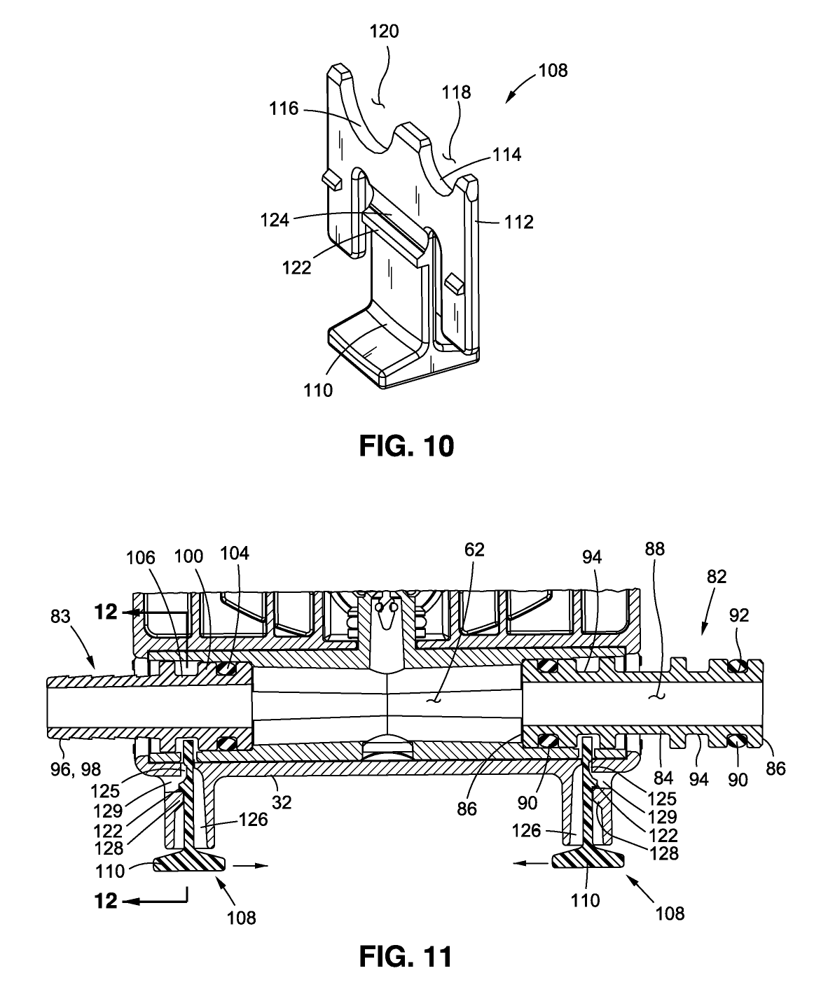

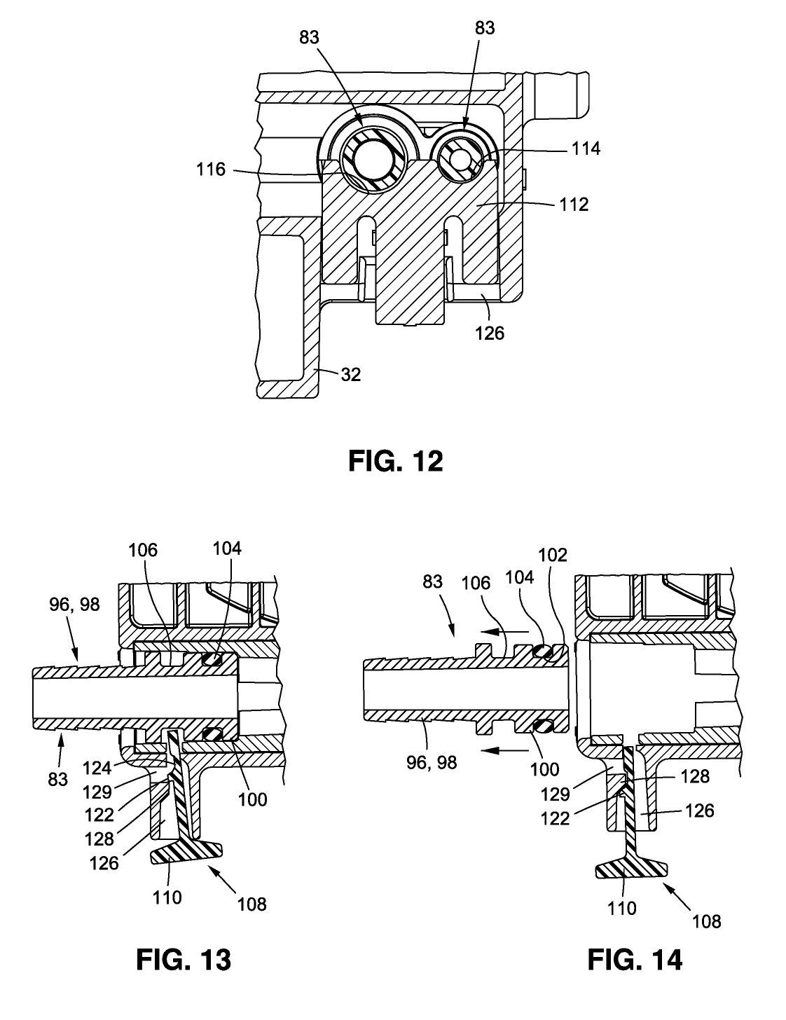

Referring now specifically to FIGS. 10-14, each mounting bracket 14 additionally includes a pair of retaining clips 108 for engaging with the fluid fittings inserted in the mounting bracket body 32 to retain the fluid fitting to the body 32 and in fluid communication with the respective first and second fluid passageways 60, 62. Each retaining clip 108 generally includes a gripping tab 110 and an engagement body 112 having a pair of arcuate edges 114, 116 defining a pair of cutouts 118, 120. Each cutout 118, 120 is adapted to accommodate a portion of a fluid fitting, with the arcuate edges 114, 116 extending into a groove formed on the fluid fitting. When the arcuate edge 114, 116 is received within the groove of the fluid fitting, the retaining clip 108 is considered to be circumferentially engaged with the corresponding fluid fitting.

The engagement body 112 of each retaining clip 108 includes a transverse spine 122 and a transverse groove 124, which interfaces with the mounting bracket body 32. In particular, the retaining clip 108 is received within a channel 126 formed on the mounting bracket body 32, with the mounting bracket body 32 having a ridge 128 that interfaces with the retaining clip 108.

Each retaining clip 108 is moveable relative to the body 32 between an engaged position and a released position. FIG. 11 is a cross sectional view showing the retaining clips 108 in their engaged positions. In particular, each retaining clip 108 extends through a slot 125 formed in the bracket body 32, with the slot 125 being aligned with the grooves 94, 106 formed on the fittings 82, 83 when the fittings 82, 83 are inserted into the bracket body 32. The retaining clip 108 is maintained in the engaged position by virtue of the engagement between the spine 122 and groove 124 on the retaining clip 108, and the ridge 128 on the bracket body 32. In particular, the spine 122 of the retaining clip 108 rests on the ridge 128 and extends into a channel 129 extending adjacent the ridge 128. In the engaged position, the distal end potion of each retaining clip 108 is received in circumferential groove 94, 106 formed on the fittings 82, 83 to circumferentially engage with the respective fluid fitting 82, 83 to retain the fluid fittings 82, 83 in fluid communication with the passageways 62.

To transition the retaining clip 108 from the engaged position to the release position, and referring now specifically to FIGS. 13 and 14, the retaining clip 108 is angled relative to its orientation in the engaged position. In particular, the spine 122 is moved out of the channel 129 so that the spine 122 no longer rests on the ridge 128. As such, the retaining clip 108 may be withdrawn from the fitting 82, 83 until the ridge 128 engages with the groove 124 formed on the retaining clip 108. The engagement between the ridge 128 and the groove 124 maintains the retaining clip in the release position. In the release position, the retaining clip 108 is spaced from the fluid fittings to allow for removal of the fluid fittings from the respective passageways 60, 62 when the retaining clip 108.

With the basic structural features of the system 10 discussed above, the following discussion will describe an exemplary use of the system 10. To construct a mounting system 10 for a plurality of pumps 12, a user connects a plurality of mounting brackets 14 together. Once assembled, the array of brackets 14 will include a first end bracket 14a and a second end bracket 14b. One or more intermediate brackets 14c may be disposed between the first and second end brackets 14a, 14c. Fluid interconnection of the brackets 14 is effectuated through the use of the fluid fittings, which are retained to the bracket body 32 by the retaining clips 10. In particular, terminal fluid couplings 83 are inserted into ports 70, 74 on the first end bracket 14a, while end caps 85 are inserted into ports 72, 74 on the second end bracket 14b. The intervening fluid connections are effectuated through the use of intermediate fluid couplings 82. In this regard, each intermediate coupling 82 will be coupled to one bracket 14 initially, while the port in the corresponding adjacent bracket 14 is initially left open to receive the intermediate coupling 82 when the brackets 14 are joined. When each fluid fitting is inserted into the mounting bracket body 32, the fitting is retained therein through a retaining clip 108, which transitions from the released position to the engaged position to retain the fitting.

The brackets 14 are connected together by aligning the fittings and the connectors 38, 40. Once aligned, the brackets 14 are pressed together until the connectors 38, 40 are engaged with each other. When the brackets 14 are connected together, the first fluid passageways 60 of the brackets 14 are in fluid communication with each other to define a collective first fluid passageway. Likewise, the second fluid passageways 62 are in fluid communication with each other to define a collective second fluid passageway.

A source of pressurized fluid is then connected to the system 10 via terminal end coupling 83a, which serves as an inlet to the collective first fluid passageway. The pressurized fluid then flows through the collective first fluid passageway, which remains closed off by the check valves 78 in the individual brackets 14, as well as the end cap 85. Thus, the pressure within the collective first fluid passageway may be equal to the pressure of the pressurized fluid source. Prior to any pumps 12 being coupled to the brackets 18, the collective second fluid passageway, which will ultimately function as an exhaust line, remains open to the ambient environment, or a discharge tank.

The pumps 12 are connected to the brackets 14, with each pump 12 being connected to a respective bracket 14. To connect the pumps 12 to the brackets 14, the grooves 22 formed on the body 16 of a pump 12 are aligned with the ridges 58 extending along the sidewalls 46 of the bracket body 32, with the pressurized fluid inlet 24 and pressurized fluid outlet 26 of the pump 12 facing the mounting bracket 14. The pump 12 is then advanced into the cavity 56, with the ridges 58 extending into the grooves 22, as the pump 12 moves into the cavity 56.

The pump 12 continues to move into the cavity 56, until the locking tab 54 locks the pump 12 in its seated position within the bracket 14. In the seated position, the pump 12 engages with the valve 78 to move the valve 78 to its open position, thereby placing the pressurized fluid inlet 24 in fluid communication with the first fluid passageway 60. Likewise, the pump 12 engages with the valve 80 to move the valve 80 to its open position, thereby placing the pressurized fluid outlet 26 in fluid communication with the second fluid passageway 62.

The process of connecting the pump 12 to the bracket 14 is repeated for each pump 12 included in the system. In this regard, by simply connecting the pump 12 to the bracket 14, each pump 12 will be placed in fluid communication with the collective first fluid passageway, and the collective second fluid passageway. Furthermore, until the pump 12 is seated within the bracket 14, the first valve 78 and second valve 80 in the bracket 14 remain in their respective closed positions, thereby allowing any pressurization within the first and second fluid passageways 60, 62 to be maintained.

When the pump(s) 12 are connected to the brackets 14, the pressurized fluid is received into the system 10 via the terminal end coupling 83a and flows through the first fluid passageway 60. The pressurized fluid in the first fluid passageway 60 may flow into any pump 12 connected to its corresponding bracket 14 via the valve 78 and the pressurized fluid inlet 24. The pressurized fluid then flows through the pump 12 to operate the pump 12. The pressurized fluid is then discharged by the pump 12 via the pressurized fluid outlet 26 and into the second fluid passageway 62 via the second valve 80. The pressurized fluid can then flow through the collective second fluid passageway 62 and be discharged from the system 10 via the terminal end coupling 83b.

Routing the exhausted gas through common exhaust plumbing, i.e., the collective second fluid passageway 62, provides for ease in handling the exhausted gas. As noted above, Carbon Dioxide is a commonly used gas for driving the pump(s) 12, and is thus the gas that is commonly exhausted from the pump(s) 12. In non-ventilated rooms, or rooms with poor ventilation, the buildup of Carbon Dioxide may create health concerns. Carbon Dioxide is heavier than oxygen, and thus, if Carbon Dioxide is exhausted into the room, the Carbon Dioxide may displace the oxygen in the room, thereby leading to potential breathing issues for anyone in the room. In many conventional pump systems, wherein each pump includes a separate outlet which vents into the ambient room, it is tedious to connect separate ventilation lines or a ventilation manifold to route the exhausted gas to a safer location. Accordingly, in some instances, such safety measures are left undone. The common exhaust plumbing of the current mounting system 10 provides a single exhaust outlet, which may be connected to a ventilation line, to deliver the exhausted gas to a safer exhaust location.

To disconnect a pump 12 from the bracket 14, the locking tab 54 is pressed to transition the tab 54 from its locked position to its unlocked position, thereby providing an unobstructed pathway for the pump 12 to be removed from the bracket 14. The pump 12 is then moved out of the cavity 56 to separate the pump 12 from the bracket 14. Movement of the pump 12 out of its seated position in the bracket 14 automatically causes the first valve 78 and second valve 80 of the bracket 14 to transition from their respective open positions to their respective closed positions.

The ability to connect and disconnect the pump(s) 12 to and from the brackets 14 is made possible by the integrated fluid flow passageways 60, 62 and the corresponding check valves 78, 80 integrated into the brackets 14. In this regard, plumbing connections separate from those already integrated into the brackets 14 are not required. As such, adding pumps 12 to the system 10 or removing pumps 12 to the system 10 is easily done through the use of the mounting brackets 14.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

1. A mounting bracket for a pressurized fluid operated pump having a pressurized fluid inlet and a pressurized fluid outlet, the mounting bracket comprising:
a body having a first mounting region and a second mounting region, the body being engageable with the pump;
a first fluid passageway extending between the first mounting region and the second mounting region, the first fluid passageway having a pair of first ports located at respective ones of the first mounting region and the second mounting region;
a second fluid passageway separate from the first fluid passageway and extending between the first mounting region and the second mounting region, the second fluid passageway having a pair of second ports located at respective ones of the first mounting region and the second mounting region;
a first valve coupled to the body and in fluid communication with the first fluid passageway, the first valve being in a normally closed position; and
a second valve coupled to the body and in fluid communication with the second fluid passageway, the second valve being in a normally closed position;
the first valve and the second valve being sized and structured such that engagement of the pump with the body causes the first valve and the second valve to transition from their respective normally closed positions to respective open positions to fluidly couple the pressurized fluid inlet and the pressurized fluid outlet with respective ones of the first and second fluid passageways;
the first mounting region and the second mounting region being engageable with respective ones of adjacent mounting brackets.

2. The mounting bracket recited in claim 1, wherein the first mounting region includes a male connector and the second mounting region includes a female connector.

3. The mounting bracket recited in claim 1, wherein the body includes a pair of opposed ridges adapted to engage with a corresponding pair of grooves on the pump to align the pump relative to the bracket when the pump is engaged with the bracket.

4. The mounting bracket recited in claim 1, further comprising a first tube coupled to the body and defining the first fluid passageway, and a second tube coupled to the body and defining the second fluid passageway.

5. The mounting bracket recited in claim 1, wherein the body includes a cavity and a locking mechanism, the cavity being sized and shaped to receive at least a portion of the pump, the locking mechanism being sized and shaped to engage with the pump when the at least a portion of the pump is received in the cavity to retain the at least a portion of the pump within the cavity.

6. The mounting bracket recited in claim 5, wherein the cavity is at least partially defined by a base plate, the locking mechanism including a tab moveable relative to the base plate.

7. The mounting bracket recited in claim 1, further comprising a pair of fluid fittings adapted to be insertable within respective ones of the first and second passageways.

8. The mounting bracket recited in claim 7, further comprising a retaining clip moveable relative to the body between an engaged position and a released position, the retaining clip engaging the pair of fluid fittings to retain the fluid couplings in fluid communication with the respective ones of the first and second passageways when the retaining clip is in the engaged position, the retaining clip being spaced from the pair of fluid fittings to allow for removal of the fluid fittings from the respective ones of the first and second passageways when the retaining clip is in the released position.

9. The mounting bracket recited in claim 1, further comprising a pair of end caps insertable within respective ones of the first and second passageways, each end cap being sized and shaped to block the respective one of the first and second passageways when inserted therein.

10. A modular mounting system for a plurality of fluid pumps, the modular mounting system including a plurality of mounting brackets, each mounting bracket comprising:
a body having a first mounting region and a second mounting region, the body being engageable with a respective one of the plurality of pumps;
at least one control passageway, each control passageway extending between the first mounting region and the second mounting region and having an access port between the first mounting region and the second mounting region, the at least one control passageway being fluidly connectable to a pressurized fluid source; and
a valve coupled to the body and in fluid communication with the access port, the valve being in a normally closed position;
the valve being transitionable from the normally closed position to an open position in response to engagement of the pump with the body to allow fluid to exit the corresponding control passageway through the access port to fluidly couple the pump to the at least one control passageway;
the plurality of mounting brackets being selectively engageable with each other by connecting the first mounting region of a first one of the plurality of mounting brackets with the second region of a second one of the plurality of mounting brackets;
the at least one control passageways of the plurality of mounting brackets being in fluid communication with each other when the plurality of mounting brackets are engaged with each other.

11. The modular mounting system recited in claim 10, wherein the first mounting region includes a male connector and the second mounting region includes a female connector.

12. The modular mounting system recited in claim 10, wherein the body includes a pair of opposed ridges adapted to engage with a corresponding pair of grooves on the pump to align the pump relative to the bracket when the pump is engaged with the bracket.

13. The modular mounting system recited in claim 10, wherein each mounting bracket includes at least one tube coupled to the body and defining the at least one control passageway.

14. The modular mounting system recited in claim 10, wherein the body includes a cavity and a locking mechanism, the cavity being sized and shaped to receive at least a portion of the respective one of the plurality of pumps, the locking mechanism being sized and shaped to engage with the respective one of the plurality of pumps when the at least a portion of the respective one of the plurality of pumps is received in the cavity to retain the at least a portion of the respective one of the plurality of pumps within the cavity, the access port being located within the cavity.

15. The modular mounting system recited in claim 14, wherein the cavity is at least partially defined by a base plate, the locking mechanism including a tab moveable relative to the base plate.

16. The modular mounting system recited in claim 10, further comprising a fluid coupling adapted to be insertable within the at least one control passageway and sized and shaped to facilitate fluid interconnection between adjacent ones of the plurality of mounting brackets.

17. The modular mounting system recited in claim 16, further comprising a retaining clip moveable relative to the body between an engaged position and a released position, the retaining clip engaging the fluid couplings to retain the fluid couplings in fluid communication with the at least one control passageway when the retaining clip is in the engaged position, the retaining clip being spaced from the fluid coupling to allow for removal of the fluid coupling from the at least one control passageway when the retaining clip is in the released position.

18. The modular mounting system recited in claim 10, further comprising an end cap insertable within the at least one control passageway and sized and shaped to block the at least one control passageway when inserted therein.

19. A mounting bracket for a gas-driven pump, the mounting bracket comprising:
a body releasably engageable with the pump;
a pair of fluid control passageways, each fluid control passageway extending within the body and having a pair of ports sized and shaped to allow for selective fluid connection with a separate, adjacent mounting bracket; and
a pair of check-valves coupled to the body and in fluid communication with a respective one of the pair of fluid control passageways, each check-valve being engagable with the gas-driven pump, and sized and structured such that engagement of the gas-driven pump with the check-valve causes the check-valve to transition from a normally closed position to an open position.

20. The mounting bracket recited in claim 19, wherein the body includes a pair of opposed ridges adapted to engage with a corresponding pair of grooves on the pump to align the pump relative to the bracket when the pump is engaged with the bracket.
